(19) United States
(12) Patent Application Publication
(10) Pub. No.: US 2014/0210200 A1
(43) Pub. Date: Jul. 31, 2014

(54) Optically Variable Security Element Comprising Optically Variable Colour Layer

(71) Applicant: GIESECKE & DEVRIENT GMBH, Munchen (DE)

(72) Inventors: Alexander Bornschlegl, Munchen (DE); Christoph Mengel, Holzkirchen (DE)

(73) Assignee: GIESECKE & DEVRIENT GMBH, Munchen (DE)

(21) Appl. No.: 14/009,168

(22) PCT Filed: Mar. 1, 2012
(86) PCT No.: PCT/EP12/00903

§ 371 Date: Oct. 1, 2013

(30) Foreign Application Priority Data
Apr. 1, 2011 (DE) 10 2011 015 837.5

(51) Int. Cl. B42D 15/00

(52) U.S. Cl. CPC B42D 15/0013
USPC 283/85; 29/407.09

(57) ABSTRACT

An optically variable security element for securing valuable articles has an optically variable color layer. The optically variable color layer includes a plurality of microcapsules, each of which exhibits a capsule shell, a carrier liquid enclosed in the capsule shell, and at least one optically variable and magnetically alignable pigment that is substantially freely rotatable in the microcapsule and reversibly alignable by an external magnetic field, and that is developed to be multilayer having at least one magnetic layer and having at least one non-magnetic layer.

The present invention relates to an optically variable security element for securing valuable articles, having an optically variable color layer. The present invention further relates to a method for manufacturing such a security element, a security arrangement having such a security element and a correspondingly equipped data carrier.

For protection, data carriers, such as value or identification documents, but also other valuable articles, such as branded articles, are often provided with security elements that permit the authenticity of the data carrier to be verified, and that simultaneously serve as protection against unauthorized reproduction. The security elements can be developed, for example, in the form of a security thread embedded in a banknote, a cover foil for a banknote having a hole, an applied security strip, a self-supporting transfer element, or also in the form of a feature region imprinted directly on a value document.

Security elements that display viewing-angle-dependent visual effects play a special role in safeguarding authenticity, as these cannot be reproduced even with the most modern copiers. Also magnetically alignable effect pigments that can be aligned magnetically in the form of a motif to be depicted have been used for this purpose for some time.

From document WO 2009/074284 A2 is known a combination of first optically variable effect pigments and second effect pigments that are reversibly alignable by an external magnetic field. Here, the optically variable effect of the first effect pigments interacts with the interactively triggerable, three-dimensional-seeming appearances that are produced by the magnetically alignable second effect pigments.

Proceeding from this, it is the object of the present invention to further improve optically variable security elements having magnetically alignable magnetic pigments and especially to specify easily and economically manufacturable optically variable security elements having an attractive visual appearance. Ideally, the advantageous properties should be achieved with the most economical use of or even with complete dispensation with substances that are hazardous to health or the environment.

This object is solved by the security element having the features of the main claim. A method for manufacturing such a security element, a security arrangement having such a security element, and a correspondingly equipped data carrier are specified in the coordinated claims. Developments of the present invention are the subject of the dependent claims.

According to the present invention, the optically variable color layer of a generic security element includes a plurality of microcapsules, each of which exhibits a capsule shell, a carrier liquid enclosed in the capsule shell, and at least one optically variable and magnetically alignable pigment that is substantially freely rotatable in the microcapsule and reversibly alignable by an external magnetic field, and that is developed to be multilayer having at least one magnetic layer and having at least one non-magnetic layer.

In the context of the present invention, under the formulation “optically variable” or “optical variability” is understood the change of a viewer-detectable optical property of an inventive security element or data carrier, having an inventive color layer, that is viewed by the viewer. Among the variable optical properties are understood to be, in agreement with the explanations on the website “http://de.wikipedia.org/wiki/ink % C3% A4ttigung”, especially those properties of a color that people consider to be fundamental, specifically hue, brightness and color saturation. Further, the quality of the color effect on a viewer of a security element according to the present invention can be described by values such as variegation, colorfulness (color intensity), chromaticity, color depth, brillance and gray cast. Further, the security elements, data carriers or color layers according to the present invention can also be characterized by further optical properties, for example by their reflectivity.

If, when an inventive security element or data carrier having an inventive color layer is viewed, for example one of the above-mentioned optical properties, especially the hue, the brightness, the color saturation or the reflectivity of the viewed security element, data carrier or color layer, changes for the reasons described below, this is referred to, in the context of the present invention, as an optically variable security element, data carrier or an optically variable color layer.

A security element according to the present invention or a data carrier according to the present invention can now, for various reasons, exhibit changed optical properties with respect to the viewer. For example, the optical properties of the viewed security element/data carrier can change when the security element/data carrier is tilted, because one or more of the above-mentioned optical properties are different under different viewing angles. That is, the viewer perceives different image impressions when a security element/data carrier according to the present invention is viewed under different viewing angles. A tilt effect that is relatively clearly perceptible for the viewer, and thus a tilt effect that is particularly valuable for the counterfeit protection of the security element or data carrier according to the present invention, is a so-called color-shift effect, that is, the change of the hue of the viewed security element when the viewing direction is changed. As already mentioned, however, according to the present invention, the term “optically variable” comprises any change in an optical property of the viewed security element/data carrier, so for example also the change in the brightness, the color saturation or the reflectivity when the security element or data carrier is tilted.

The optically variable effect of a security element/data carrier according to the present invention can have different causes. For one, the optical properties of the security element/data carrier according to the present invention or the color layer according to the present invention that are detectable by the viewer can change due to the optically variable and magnetic pigments used according to the present invention, as explained above, when the security element/data carrier is tilted. That is, the optical variability of the security element/data carrier is the result of the change in the viewing angle with respect to the optically variable and magnetically alignable pigments. On the other hand, given a fixed viewing angle with respect to the security element/data carrier, the viewer can perceive a changed image impression of the security element/data carrier at least in those regions in which the orientation of the optically variable, magnetically alignable pigments is changed by applying a magnetic field. In other words: for the security element according to the present invention, it is not important whether the image impression changes for the viewer due to tilting the security element/data carrier and the optically variable, magnetically alignable pigments included in the color layer, or whether the image impression changes due to a change in the orientation of the pigments when the viewing direction is per se fixed.

Further, it is to be noted that the term “optically variable” also applies to security elements, data carriers, color layers or magnetically alignable pigments according to the present invention in which the optical variability is induced, not by tilting the security element or changing the orientation of the magnetically alignable pigments, but rather by changing the illumination direction of a light source used.

Moreover, it is further to be noted that the above-described optically variable effect is perceptible for a viewer, that is, must be present at least in the visible wavelength range from approximately 380 nm to 780 nm. Of course the optically variable effect can, furthermore, also occur in the wavelength range from less than 380 nm or more than 780 nm, making a machine detection possible also in the non-visible wavelength range.

The present invention is based on the idea of optimizing the properties of the security elements in such a way that systematically selected magnetic pigments are arranged in the microcapsules of the optically variable color layer, specifically magnetically alignable pigments that simultaneously provide the desired optical variability. The inventors surprisingly found, namely, that it is possible to produce visually very impressive tilt effects, especially color-shift effects, with pigments that combine the two properties mentioned. The currently common addition of colorants to the carrier liquid of the microcapsules, or the addition of further colored or optically variable pigments to the color layer, can thus be dispensed with. In this way, the manufacture of the security elements is made simpler and more economical, without the visual impression of the security elements being disadvantageously impacted. In addition, the multilayeredness of the pigments facilitates great freedom in the design of the layer structure, since different sub-layers can be combined with desired functionality in a pigment. Further, the security element according to the present invention, having optically variable and simultaneously magnetic properties, exhibits, due to the achievable impressive optically variable effects, a very high recognition value and thus very high counterfeit protection. Also, through this measure, substances that are questionable in terms of health and/or environmental factors can largely be dispensed with.

The proportion by weight of the magnetic substances in the encapsulated pigments advantageously lies between 10% and 90%, preferably between 35% and 75%.

Without an external magnetic field, the pigments are preferably isotropically aligned within the microcapsules, that is, as a whole, they exhibit no preferred direction. Here, in practice, certain deviations from the ideal isotropic alignment can, of course, occur, depending, for example, on the geometric shape, the magnetizability, the viscosity of the carrier liquid or the structure of the encapsulation.

In a preferred embodiment, the pigments comprise non-spherical pigments, especially pigments that are developed to be platelet-shaped, the ratio of the largest to the smallest diameter (diameter-to-thickness ratio) of the non-spherical pigments being more than 4:1, preferably more than 10:1 and particularly preferably lying between 20:1 and 200:1. The largest diameter of the non-spherical pigments preferably lies between 2 μm and 150 μm, especially between 5 μm and 50 μm.

Platelet-shaped magnetic pigments, especially in the preferred size range and in the preferred diameter-to-thickness range, can be oriented as desired relative to the layer plane by an external magnetic field. They then, like the slats of a blind, according to orientation, either largely reveal the view of underlying layers (nearly perpendicular orientation relative to the layer plane) or block it partially (oblique orientation relative to the layer plane) or completely (substantially horizontal orientation relative to the layer plane). In this way, in the case of high diameter-to-thickness ratios, it is possible to set high contrasts between translucent and opacifying layer regions.

Magnetic interference pigments having a Fabry-Perot structure, magnetic oxidic multilayer pigments and coated magnetic pure iron pigments have proven to be particularly well suited. The microcapsules thus advantageously include one or more of these pigment types.

Likewise advantageous is the use of pigments in the form of magnetic metallic nanoparticles having a non-magnetic carbon casing, especially a graphene casing. Such nanoparticles preferably exhibit a diameter between 20 nm and 50 nm. They can be provided alternatively or in addition to the non-spherical, especially platelet-shaped magnetic pigments in the microcapsules.

It is conceivable that the microcapsules include multiple pigments, for example a magnetically alignable and optically variable pigment according to the present invention and, in addition, a second magnetically alignable and/or optically variable pigment. However, also encapsulated pigments having different properties, especially different magnetic properties, can be used in a security element, such that, due to the different properties of the pigments, for example first and second pieces of information are made visible by means of a first and second external magnetic field, the first piece of information being able to be made visible upon application of the first external magnetic field to the security element, and the second piece of information upon application of the second external magnetic field.

The carrier liquid preferably consists of a mixture of up to four substance classes, specifically of 10% to 98% of a non-polar carrier medium, of 0 to 90% of an amphiphilic carrier medium, of 0 to 10% of an oxidation-protective substance, and of 0 to 10% additives. The additives are especially wetting and dispersing additives, for example block copolymers, UV or IR absorbers, polymerization inhibitors or stabilizers of any kind. Otherwise, in a preferred embodiment, it is provided that the pigments are stabilized by a suitable treatment, especially the coating of the surface of the pigments, such that the magnetic and optically variable properties of the pigments according to the present invention can be maintained as long as possible. A stabilization of the pigments can occur, for example, by means of a coating of the surface of the pigments described in the text below. Generally, it is further conceivable that the carrier liquid includes additional, especially security-relevant features. These additional features can be, for example, luminescent, especially fluorescent materials. Also conceivable are materials that change color when impinged on with laser radiation. In principle, it is also conceivable that the carrier liquid includes colorant.

However, particularly advantageously, the microcapsules include no additional colorant besides the at least one optically variable and magnetically alignable pigment. Also the optically variable color layer particularly advantageously includes no further colored or optically variable pigments besides the pigments included in the microcapsules.

The carrier liquid is particularly preferably developed to be transparent. In the context of the present invention, under a “transparent” material is understood a material that lets incident electromagnetic radiation at least in the visible wavelength range from approximately 380 nm to approximately 780 nm substantially completely through. In a “transparent” material in the context of the present invention, the transmittance T≧0.8, T being defined as the quotient of the radiant power L allowed through the material and the radiant power Lₒ radiated onto the material. This exact definition of the transmittance (T=L/L₀) corresponds to the definition given in the “Lexikon der Optik”, Spektrum Akademischer Verlag, Heidelberg 2003, Volume 2, page 366, term “Transmissionsgrad”.

Furthermore, is it also conceivable that the carrier liquid is a “translucent,” “sheer” or “semitransparent” material. In the context of the present invention, such a “translucent” material exhibits, at least in the visible wavelength range from approximately 380 nm to approximately 780 nm, a transmittance T greater than 0.1 and less than 0.8, that is, 0.1<T<0.8.

The microcapsules themselves exhibit a diameter between 1 μm and 200 μm, preferably between 2 μm and 80 μm. It is understood that the diameter of the microcapsules is advantageously coordinated with the size of the encapsulated magnetic pigments. The wall thickness of the microcapsules typically lies between 2% and 30%, preferably between 5% and 15% of the diameter of the microcapsules.

In a development of the present invention, the optically variable color layer can be applied on an information-bearing background layer, especially a screen printing, flexographic printing or intaglio printing layer. Furthermore, the optically variable color layer can also advantageously be arranged on a substantially contiguous background layer, particularly a colored background layer. For example, the background layer can exhibit a complementary color to the color of the optically variable layer without applying a magnetic field, such that the viewer can, upon application of a magnetic field and the resulting alignment of the magnetic pigments, at least partially perceive the hue of the complementary color of the background layer. Also conceivable are embodiments in which the hue of the background layer is coordinated with the hue of the optically variable color layer in such a way that the color impression for the viewer changes upon application of a magnetic field to the security element.

The optically variable color layer can also be combined with a thermochromic or magnetic background layer, the magnetic background layer preferably being present in the form of patterns, characters or a code.

The present invention also comprises a method for manufacturing an optically variable security element for securing valuable articles, in which there is applied to a substrate an optically variable color layer that includes a plurality of microcapsules, each of which exhibits a capsule shell, a carrier liquid enclosed in the capsule shell, and at least one optically variable and magnetically alignable pigment that is substantially freely rotatable in the microcapsule and reversibly alignable by an external magnetic field, and that is developed to be multilayer having at least one magnetic layer and having at least one non-magnetic layer.

The present invention further includes a security arrangement for securing security papers, value documents and the like, having a security element of the kind described above and having a verification element having a magnetic region. In the magnetic region, advantageously, magnetic material is present in the form of patterns, lines, characters or a code. The motif depicted by the magnetic material can be openly visible or also be hidden without auxiliary means, for example by covering with a dark print layer. The magnetic region is preferably magnetized substantially perpendicular to the plane of the verification element.

The present invention further comprises a data carrier, especially a value document, such as a banknote, a passport, a certificate, an identification card or the like, that is furnished with a security element of the kind described or with a security arrangement of the kind described. If the data carrier includes both a security element according to the present invention and an associated verification element, then these are advantageously arranged geometrically on the data carrier in such a way that the security element is bringable over the verification element by bending or folding the data carrier.

The data carrier in the form of a banknote can especially be a paper banknote, polymer banknote or a foil-paper composite banknote. The data carrier in the form of an identification card can advantageously be a credit card, bank card, a cash card, an authorization card, an identity card or a passport personalization page.

Furthermore, the security element according to the present invention can, however, also be used to safeguard products of any kind, that is, for so-called product protection. For example, with the security element according to the present invention, packaging of any kind can be protected against imitation. Also, besides product protection, the security element according to the present invention can advantageously be used for brand protection.

Further exemplary embodiments and advantages of the present invention are explained below by reference to the drawings, in which a depiction to scale and proportion was omitted in order to improve their clarity.

Shown are:

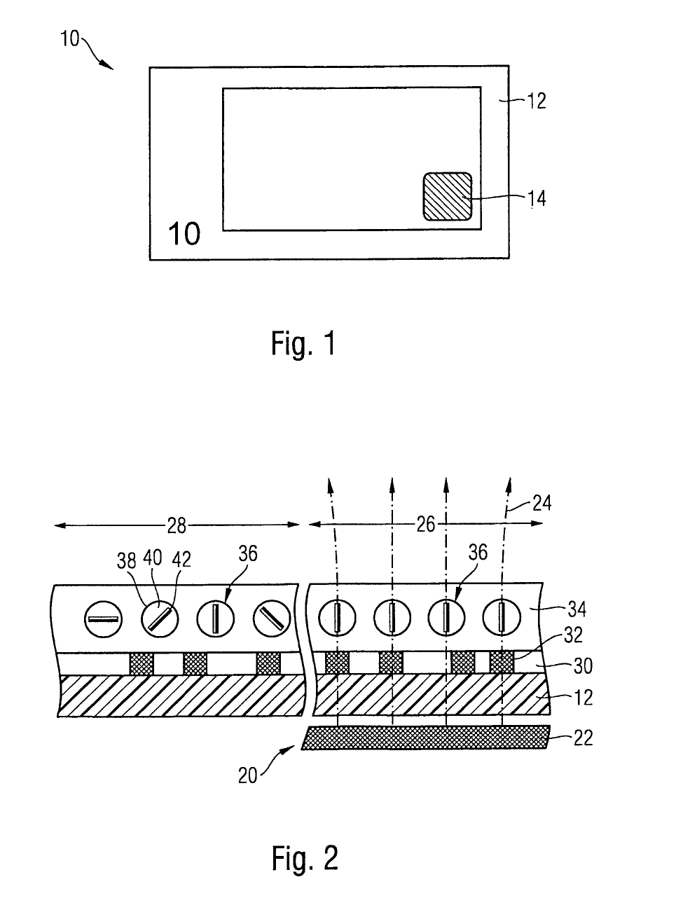

FIG. 1 a schematic diagram of a banknote having a security element according to the present invention,

FIG. 2 a cross section through a security element according to an exemplary embodiment of the present invention, in the left image half without a verification device and in the right image half with,

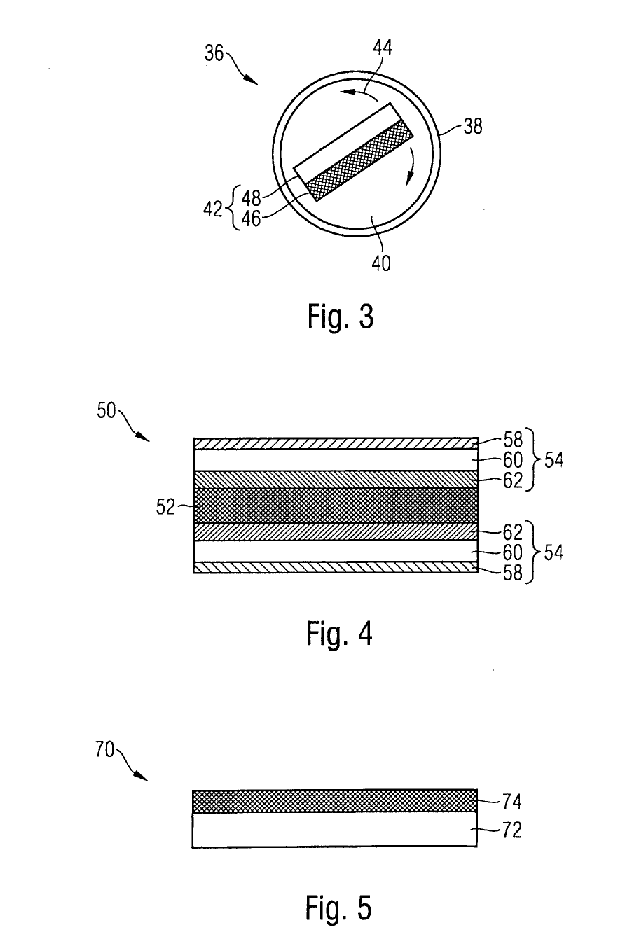

FIG. 3 schematically, singled out of the color layer in FIG. 2, a microcapsule and its components, in cross section,

FIG. 4 an optically variable, magnetic interference pigment according to an exemplary embodiment of the present invention,

FIG. 5 a magnetic multilayer pigment according to a further exemplary embodiment of the present invention,

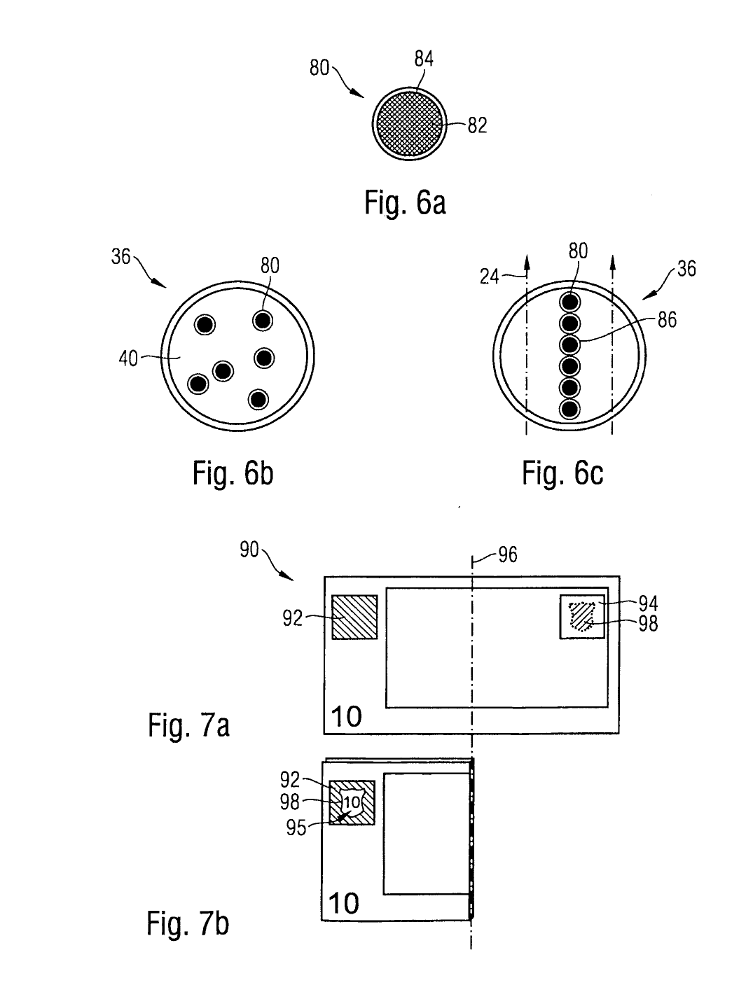

FIG. 6 in (a), a magnetic multilayer pigment in the form of a nanoparticle having a magnetic metallic core and a non-magnetic carbon casing, in (b), a microcapsule having a plurality of such nanoparticles without an external magnetic field, and in (c), the microcapsule in (b) in the magnetic field of a verification device,

FIG. 7 in (a) and (b), a banknote having a security arrangement according to the present invention, composed of a security element and a verification element arranged in mirror image to the centerline,

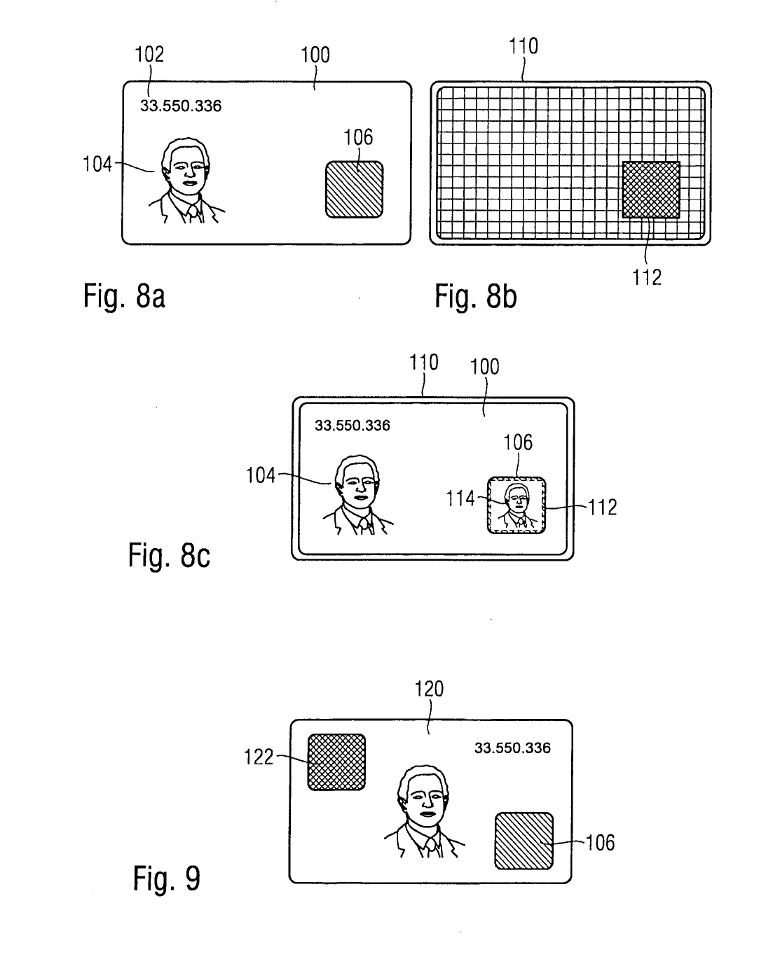

FIG. 8 in (a), an identification card having a security element according to the present invention, in (b), a card receptacle having a verification device for the identification card in (a), and in (c), the card receptacle having an inserted identification card, and

FIG. 9 an identification card having a further security arrangement according to the present invention.

The invention will now be explained using the example of security elements for banknotes and other value documents. For this, FIG. 1 shows a schematic diagram of a banknote 10 having an optically variable security element 14 imprinted directly on the banknote paper 12. The present invention is, however, not limited to imprinted security elements and banknotes, but rather can be used in all kinds of security elements, for example in labels on goods and packaging, or in safeguarding documents, identity cards, passports, credit cards, health cards and the like. In banknotes and similar documents, besides imprinted elements, for example also transfer elements, security threads or security strips, and besides top-view elements, also see-through elements may be considered.

The security element 14 exhibits a reversible and, through a magnetic verification device 20 (FIG. 2), interactively triggerable authenticity mark. Without a verification device or with a sufficient spatial distance from the verification device, the security element 14 displays a metallic gloss that is combined with a weakly pronounced, uniform optical effect, preferably a color-shift effect.

In the exemplary embodiment, the verification device 20 includes a strong permanent magnet 22 composed of a neodymium-iron-boron alloy that is designed in the form of patterns, lines, characters or a code, for example in the form of the letters “OK”. Here, the top of the magnet 22 forms a magnetic north pole and the underside a magnetic south pole, such that the magnetic field lines 24 of the magnet 22 are substantially perpendicular to the plane of the magnet 22.

If the security element 14 is now brought by the user immediately over the magnet 22 of the verification device 20, then the visual appearance of the security element 14 is interactively changed. In a region immediately over the magnet 22 that exhibits the form of the motif depicted by the magnet 22, here for example the form of the letters “OK”, the metallic gloss of the security element is significantly reduced and a colored or information-bearing background layer becomes visible. This visual change is completely reversible. If, namely, the security element 14 is removed from the verification device 20 again, after a short time, the initial state with the metallic gloss and the uniform optical effect, preferably uniform color-shift effect, of the security element 14 is restored.

The structure of a security element according to the present invention 14 and the occurrence of the reversible change of the visual appearance will now be explained in greater detail with reference to the cross sectional depiction in FIG. 2. Here, the left image half in the figure shows the security element 14 without the verification device 20 or a region 28 apart from the magnet 22, while the right image half shows a region 26 of the security element that is located immediately over the magnet 22.

To the banknote paper 12 of the banknote 10 is applied in the region of the security element 14 a print layer 30 that can depict an arbitrary piece of information, such as a line pattern 32, an alphanumerical character string, a logo, a portrait or the like. Over this print layer 30 is applied, in the screen printing method, an optically variable color layer 34 that is opaque under normal conditions and that displays a color-shift effect, for example from green when viewed perpendicularly from above to blue when viewed obliquely.

The optically variable color layer 34 includes a plurality of microcapsules 36, each of which exhibits a capsule shell 38, a carrier liquid 40 enclosed in the capsule shell 38, and at least one optically variable and magnetically alignable pigment 42. As can best be seen in the detailed depiction in FIG. 3, here, the pigment 42 is substantially freely rotatable 44 in the microcapsule 36 and reversibly alignable by an external magnetic field, such as the field 24 of the permanent magnet 22. Further, according to the present invention, the pigment 42 is developed to be multilayer and exhibits at least one magnetic layer 46 and at least one non-magnetic layer 48.

In the exemplary embodiment in FIGS. 2 and 3, the pigments 42 constitute coated magnetic pure iron pigments in which magnetic carbonyl iron particles 46 are provided with a non-magnetic silicon dioxide coating 48. Such pigments display, when the viewing angle is changed, a pronounced color shift from gray-metallic to black-metallic. Pigments of this kind are available, for example, under the trade name Ferricon (R) Resist from Eckart.

In the context of the present invention, the platelet-shaped pigments 42 are produced having a high ratio of platelet diameter to platelet thickness, the (largest) platelet diameter preferably being between 2 μm and 150 μm, especially between 5 μm and 50 μm, and the platelet thickness preferably lying between 40 nm and 1.5 μm, especially between 200 nm and 1.3 μm.

Since the pigments 42 are substantially freely rotatable within the capsule shell 38, without an external magnetic field, they exhibit no preferred orientation. The pigments 42 are then aligned substantially randomly and thus, overall, isotropically. The even distribution of the alignment of the pigments 42 in all directions is depicted schematically in the left image half in FIG. 2.

In the region 26 immediately over the magnet 22, in contrast, the magnetically alignable pigments 42 are magnetically aligned due to their rotatability in the capsule shell 38. Here, the platelet-shaped pigments 42 align themselves with their platelet dimension along the magnetic field lines 24. In the situation shown in FIG. 2, the magnetic field lines 24 in the region 26 pass through the color layer 34 substantially perpendicularly and thus align the pigments 42 likewise substantially perpendicular to the plane of the color layer 34 (right image half in FIG. 2).

Due to their platelet-shaped design, the pigments 42 seem for the viewer like the slats of a blind that reveal or completely or partially block the view of the underlying print layer 30, 32. In the regions 28, in which the pigments 42 are arranged substantially isotropically in their capsule shells 38 (left image half in FIG. 2), they restrict the view of the print layer 30 so strongly that the color layer 34 in this region appears opaque and the metallic gloss and the color-shift effect of the pigments 42 dominate the visual impression of the security element 14. It is understood that, in practice, the opacifying effect of the isotropically oriented pigments 42 is enhanced by the plurality of the pigments present, the number of which, of course, is many times greater than the few pigments 42 in the schematic diagram in FIG. 2.

In the region 26 in which the pigments 42 are aligned substantially perpendicular to the plane of the color layer 34 by the magnet 22, said pigments reveal, in contrast, like the slats of a blind set to parallel, the view of the underlying print layer 30 and the line pattern 32. Due to the size ratio of platelet diameter to platelet thickness, a high contrast results between the opacifying sub-regions 28 and the translucent sub-regions 26. Furthermore, the motif produced by the platelet alignment in the sub-regions 26, 28 appears for the human eye having an effective, three-dimensional-seeming appearance.

If the security element 14 is removed from the magnet 22 again, then the magnetically aligned pigments 42, due to their mobility within the capsule shell 38, relax again after some time into the substantially isotropic initial state in the left image half in FIG. 2. The change in the visual appearance of the security element 14 is also interactively triggered and is completely reversible. The speed with which the pigments 42 return to their initial state can be set as desired within a broad scope, for example through the viscosity of the carrier liquid 40.

It proved that, through the micro-encapsulation of both the optically variable and magnetically alignable pigments 42, visually very impressive effects, particularly color-shift effects, are created that, as described above, are combined with an interactive triggerable 3D-effect. Due to the achievable impressive effects, particularly color-shift effects, according to the present invention, the addition of colorant to the carrier liquid 40 and the addition of further colored or optically variable pigments to the color layer 34 can be dispensed with. In this way, a simple and economical manufacture of the security elements is facilitated, without the need to accept compromises in the quality of the visual appearance. Further, the security element according to the present invention having optically variable and simultaneously magnetic properties exhibits, due to the achievable impressive optically variable effects, a very high recognition value and thus very high counterfeit protection. Finally, the multilayeredness of the pigments 42 makes it possible to largely dispense with substances that are questionable in terms of health and/or environmental factors, such as nickel or cobalt.

Particularly advantageous embodiments of microcapsules and magnetically alignable pigments according to the present invention will now be described in greater detail with reference to FIGS. 3 to 6.

In FIG. 3, for illustration, an individual microcapsule 36 of the color layer 34 in FIG. 2 is singled out and shown schematically with its components, in cross section.

According to the present invention, the diameter of the microcapsules 36 lies between 1 μm and 200 μm, preferably between 2 μm and 80 μm. The capsule shell 38 of the microcapsules 36 consists of a polymeric shell material. Encapsulation methods and suitable shell materials are known to the person of skill in the art. In particular, aminoplasts, phenoplasts, gelatins and modified gelatins, polyurethanes and polyacrylates are suitable as the shell material. In the context of the present invention, the thickness of the capsule shell 38 is typically between 5% and 30%, preferably between 10% and 20% of the capsule diameter.

In advantageous designs, the capsule shell 38 includes, besides the polymeric base material, a further layer that improves desired properties of the shell, for example lends the shell greater resistance to chemical influences.

The carrier liquid 40 enclosed in the capsule shell 38 expediently exhibits a viscosity of 1 mPa*s to 4,000 mPa*s, particularly from 5 mPa*s to 120 mPa*s, in each case measured at 20° C. Due to the viscosity of the carrier liquid 40, the speed of the alignment and the return of the pigments 42 to the isotropic initial state can be systematically influenced.

The carrier liquid 40 advantageously consists of a mixture of up to four substance classes, namely of 10% to 98% of a non-polar carrier medium, of 0 to 90% of an amphiphilic carrier medium, of 0 to 10% of an oxidation-protective substance and of 0 to 10% additives.

As the non-polar carrier medium, primarily fatty acid esters, especially triglycerides, formed from fatty acids having on average not more than 1.5 double bonds may be considered. Alternatively or additionally, hydrocarbons, expediently having a flash point above 65° C., preferably even above 80° C., can be used as the non-polar carrier medium. Here, saturated hydrocarbons are preferred, and according to current knowledge, isoparaffins are particularly well suited. Also vegetable oils, such as sunflower, olive or grapeseed oil and/or silicone oils can, alternatively or additionally, be used as the non-polar carrier medium.

The amphiphilic carrier medium is particularly preferably present in a proportion by weight of 4% to 40%. Ionic tensides, phospholipids, fatty alcohols, fatty alcohol derivatives and fatty acid derivatives, for example, are suitable as the amphiphilic carrier medium. Particularly preferred, currently, are non-ionic tensides, or generally, surface-active substances having an HLB (hydrophilic-lipophilic balance) value according to Davies of less than 4.0, especially from 1.0 to 1.1. For example, a substance that exhibits an HLB value according to Davies of 1.03 can be used as the amphiphilic carrier medium. Of course, also mixtures of the mentioned substances may be considered as the amphiphilic carrier medium.

As the oxidation protection, the carrier liquid can, for example, include tocopheroles, tocotrienoles or aldehydes. As the additives, particularly infrared absorbers or UV absorbers, such as hydroxyphenylbenzotriazoles, polymerization inhibitors, stabilizers, wetting and dispersing additives, hydroxybenzophenone derivatives or nanoparticulate UV absorbers may be considered.

Finally, the microcapsules 36 each include one or more optically variable, magnetically alignable multilayer pigments 42. In the exemplary embodiment in FIG. 3, the multilayer pigments 42 are pure iron pigments in the form of magnetic carbonyl iron particles 46 that are provided with a non-magnetic silicon dioxide coating 48, as already described in greater detail above.

In addition to such coated magnetic pure iron pigments, according to the present invention, also other magnetic multilayer pigments can advantageously be used. Here, in a preferred variant of the present invention, the magnetic multilayer pigments are developed to be non-spherical, especially platelet-shaped, and exhibit a largest diameter between 2 μm and 150 μm, preferably between 5 μm and 50 μm. The magnetic multilayer pigments exhibit at least one magnetic layer and at least one non-magnetic layer. Here, the proportion by weight of the magnetic substances advantageously lies between 10% and 90%, particularly between 35% and 75%.

For the magnetic layers, magnetic metal oxides, especially iron oxides, and here, particularly preferably Fe₃O₄, or also chrome oxide, may be considered. Also magnetic mixed metal oxides, such as chrome iron oxide, or magnetic metals, such as iron, cobalt, nickel and gadolinium, can be used as the magnetic layers.

For the non-magnetic layers, particularly oxides, such as silicon dioxide, titanium dioxide and tin oxide, or non-magnetic metals, such as aluminum, chrome, copper or gold, may be considered. But also organic or organic silicon compounds may be considered as the non-magnetic layer materials. In particular, it was found that, for the process, pigments that are not easily suited can be used as pigments according to the present invention if the surface of these pigments is furnished with a silicon-containing layer, particularly through a silanization (stabilization of the pigments).

One of the magnetic or non-magnetic layers can also be formed by the carrier material of the pigment, for example, in pigments that are based on mica flakes, Al₂O₃ flakes, SiO₂ flakes, or pure-iron or iron-oxide flakes.

A concrete example of a particularly advantageous optically variable, magnetic interference pigment 50 is depicted in FIG. 4. The magnetic interference pigment 50 consists of a total of seven layers and includes, besides a magnetic layer, two Fabry-Perot structures that lend the pigment its optically variable appearance. The magnetic interference pigment 50 includes a metallic or oxidic magnetic layer 52 that is provided on both sides with Fabry-Perot structures 54, 56, each of which consists of a thin chrome absorber layer 58, a dielectric MgF₂ spacing layer 60 and an aluminum reflector layer 62. The two Fabry-Perot structures 54, 56 can be developed to be identical or also different, and in the latter case, display different color-shift effects from opposing sides.

FIG. 5 shows a further exemplary embodiment of a magnetic multilayer pigment 70 according to the present invention. The pigment 70 includes corundum (α-Al₂O₃) crystal flakes 72 as the carrier material, and an interference coating 74 composed of iron oxide (Fe₃O₄) and, if appropriate, in addition, titanium dioxide (TiO₂).

Alternatively, a magnetic oxidic multilayer pigment used for the security element according to the present invention can also exhibit Al₂O₃, especially corundum, as the carrier material, and a preferably two-layer interference coating composed of iron oxide and magnesium oxide. Furthermore, it is conceivable that there is arranged on the carrier material, especially corundum, an interference coating composed of iron oxide doped with magnesium oxide, particularly γ-iron oxide, the proportion of magnesium oxide preferably being up to 1 wt. %. The two above-mentioned oxidic multilayer pigments exhibit an optically variable, golden hue. Here, the formulation “optically variable” refers primarily to the change in the reflectivity or in the gloss of these pigments, since the pigments exhibit substantially no color-shift effect.

To obtain a silver-colored, optically variable and magnetic pigment, an Al₂O₃, especially corundum, carrier material can be provided with an interference coating composed of Fe₃O₄ (iron oxide) as well as one or more layers composed of SiO₂ (silicon dioxide), TiO₂ (titanium dioxide) or SnO₂ (tin oxide).

With respect to the magnetic oxidic multilayer pigments that can be used as the carrier material and as a material in the interference coating, it is to be noted, of course, that also other substances can be used. For example, as the carrier material, besides Al₂O₃, also silicon dioxide (SiO₂) or natural mica (a naturally occurring mineral) or synthetic mica can be used. Further, also synthetic glass materials are conceivable as the carrier material. All above-mentioned magnetic oxidic multilayer pigments are optically variable within the meaning of the present invention and are thus suitable as optically variable and magnetically alignable pigments in microcapsules of the optically variable color layer.

Finally, according to a further, likewise preferred variant of the present invention, the magnetic multilayer pigments are formed by nanoparticles 80 having a magnetic metallic core 82 and a non-magnetic carbon casing 84, as shown in FIG. 6(a). Such nanoparticles exhibit a diameter that lies merely between 20 nm and 50 nm, for example at about 30 nm. Iron or cobalt, for example, may be considered as magnetic metals for the core 82. The carbon casing can especially consist of one or more graphene layers that protects the metal core against oxidation. The thickness of the carbon casing preferably lies in the range of 1 nm. If the coated nanomagnets exhibit, at least to a certain extent, optically variable properties within the meaning of the definition given above, they can, in the context of the present invention, be used alternatively or in addition to the above-described non-spherical pigments.

If nanoparticles 80 are used as the magnetic pigments, then multiple nanoparticles 80 are encapsulated in each microcapsule, as shown in FIG. 6(b). Without an external magnetic field, the nanoparticles 80 are uniformly distributed in the carrier liquid 40 of the microcapsule 36 and thus lead to an opaque, optically variable appearance of the color layer 34. If the color layer 34 is brought over a verification device 20, then the nanoparticles 80 align chain-like 86 along the magnetic field lines 24, as depicted schematically in FIG. 6(c). In this state, the nanoparticles 80 reveal the view of a print layer lying thereunder. After the removal of the external magnetic field, the nanoparticles 80 relax out of the chain arrangement 86 and disperse in the volume of the microcapsule 36 such that, after some time, a state as in FIG. 6(b) is achieved again. It is also possible to realize such a reversible, interactively triggerable authenticity mark with spherical nanoparticles 80.

In the design described with reference to FIG. 2, the authenticity check of the security element 14 is done with a separate verification device 20. However, for the authenticity check, it is also possible to provide a verification element on a banknote itself, such that the security element and the verification element form a connected security arrangement, as will now be explained by reference to the exemplary embodiment in FIG. 7.

The banknote 90 shown in FIG. 7(a) includes a security element 92 of the kind described above, as well as a verification element 94 that is applied to the security element 92 mirror-symmetrically with respect to the centerline 96 of the banknote 90. The verification element 94 exhibits a magnetic region 98 in which magnetic material is present having a magnetization perpendicular to the paper plane and in the form of a desired motif, such as the crest depicted in FIG. 7(a). The motif form of the magnetic region 98 can be openly visible or also be hidden, for example by a dark overprint.

By folding the banknote 90 about the centerline 96, the verification element 96 comes to lie with its magnetic region 98 on the security element 92, as shown in FIG. 7(b). Due to the magnetization of the magnetic region 98, the visual impression of the security element 92 is interactively and reversibly changed in the manner described above. Upon superimposition, the security element 92 especially displays the crest motif of the magnetic region 98. Also further pieces of information, such as the denomination 95 of the banknote, can become visible in the interior of the crest motif. The banknote 90 can thus be checked for authenticity through simple folding, without external verification means being required.

The present invention can also be used advantageously in cards, as illustrated by reference to the exemplary embodiment in FIG. 8. FIG. 8(a) shows a top view of an identification card 100, such as a personal identity card, bank card, credit card or a driver's license. The identification card 100 typically includes one or more open markings, for example a serial number 102 and/or a portrait 104 of the card owner.

In addition, the identification card 100 includes an inventive security element 106 that, in the exemplary embodiment, is formed by a print layer having a second, diminished portrait depiction of the card owner and, imprinted on the second portrait depiction, an optically variable color layer of the kind described in connection with FIG. 2. Due to the substantially isotropic alignment of the encapsulated pigments 42, the optically variable color layer is opaque under normal conditions, such that the second portrait depiction is hidden for a viewer (FIG. 8(a)).

For authentication, the identification card 100 is laid in an associated card receptacle 110 that, as shown in FIG. 8(b), includes as the verification device a permanent magnet 112 that is coordinated with the position, size and form of the security element 106. In a genuine identification card 100, the magnetically alignable pigments 42 are aligned perpendicular to the plane of the security element 106 by the magnetization of the magnet 112 and, in this way, reveal the view of the second portrait depiction 114, as depicted in FIG. 8(c). The appearance of the second portrait depiction 114 and the agreement with the first portrait 104 can thus be used to check the authenticity of the card 100 and as proof of authorization of the card owner.

It is understood that the authenticity check can also occur in another way. For example, the permanent magnet 112 itself can be developed in the form of a motif, such as the letters “OK”, the motif of the permanent magnet 112 appearing in the security element 106 when a genuine identification card 100 is inserted into the card receptacle 110. Alternatively, also magnets as are used, for example, in loudspeakers of mobile phones, portable computers and similar technological devices, are suitable for checking the authenticity of the security element according to the present invention.

With reference to FIG. 9, identification cards 120 themselves can also include, in a further region, a verification element 122 having a motif-shaped magnetic region with which the security element 106 of a second card 120 can be checked. For authentication, the second card is laid, rotated 180°, on the first card such that the security element 106 of the second card comes to lie on the verification element 122 of the first card. The motif of the verification element 122 of the first card then becomes visible in the security element 106 of the second card. In this way, two identification cards 120 can be mutually verified.

1-16. (canceled)

17. An optically variable security element for securing valuable articles, having an optically variable color layer, wherein the optically variable color layer includes a plurality of microcapsules, each of which exhibits a capsule shell, a carrier liquid enclosed in the capsule shell, and at least one optically variable and magnetically alignable pigment that is substantially freely rotatable in the microcapsule and reversibly alignable by an external magnetic field, and that is developed to be multilayer having at least one magnetic layer and having at least one non-magnetic layer.

18. The security element according to claim 17, wherein the proportion by weight of the magnetic substances in the encapsulated pigments lies between 35% and 75%.

19. The security element according to claim 17, wherein, without an external magnetic field, the pigments are aligned substantially isotropically within their microcapsules.

20. The security element according to claim 17, wherein the pigments comprise non-spherical pigments, especially pigments that are developed to be platelet-shaped, the ratio of the largest to the smallest diameter (diameter-to-thickness ratio) of the non-spherical pigments lying between 20:1 and 200:1.

21. The security element according to claim 20, wherein the largest diameter of the non-spherical pigments lies between 5 μm and 50 μm.

22. The security element according to claim 17, wherein the pigments comprise magnetic interference pigments having a Fabry-Perot structure, magnetic oxidic multilayer pigments and/or coated magnetic pure iron pigments.

23. The security element according to claim 17, wherein the pigments comprise magnetic metallic nanoparticles having a non-magnetic carbon casing, particularly a graphene casing, that exhibit a diameter between 20 nm and 50 nm.

24. The security element according to claim 17, wherein the carrier liquid consists of 10% to 98% of a non-polar carrier medium, of 0 to 90% of an amphiphilic carrier medium, of 0 to 10% of an oxidation-protective substance, and of 0 to 10% additives, particularly UV or IR absorbers, wetting and dispersing additives, polymerization inhibitors or stabilizers.

25. The security element according to claim 17, wherein, besides the at least one optically variable and magnetically alignable pigment, the microcapsules include no additional colorant.

26. The security element according to claim 17, wherein, besides the pigments included in the microcapsules, the optically variable color layer includes no further colored or optically variable pigments.

27. The security element according to claim 17, wherein the microcapsules exhibit a diameter between 2 μm and 80 μm.

28. The security element according to claim 17, wherein the optically variable color layer is applied on an information-bearing background layer, especially an offset, screen printing, flexographic printing layer or an intaglio printing layer, and/or in that the optically variable color layer is combined with a thermochromic or magnetic background layer, the magnetic background layer being present in the form of patterns, characters or a code.

29. A method for manufacturing an optically variable security element for securing valuable articles, in which there is applied to a substrate an optically variable color layer that includes a plurality of microcapsules, each of which exhibits a capsule shell, a carrier liquid enclosed in the capsule shell, and at least one optically variable and magnetically alignable pigment that is substantially freely rotatable in the microcapsule and reversibly alignable by an external magnetic field, and that is developed to be multilayer having at least one magnetic layer and having at least one non-magnetic layer.

30. A security arrangement for securing security papers, value documents, data carriers and the like, having a security element according to claim 17 and having a verification element having a magnetic region.

31. The security arrangement according to claim 30, wherein, in the magnetic region, magnetic material is present in the form of patterns, lines, characters or a code, and/or in that the magnetic region is magnetized substantially perpendicular to the plane of the verification element.

32. A data carrier having an optically variable security element for securing valuable articles, having an optically variable color layer, wherein the optically variable color layer includes a plurality of microcapsules, each of which exhibits a capsule shell, a carrier liquid enclosed in the capsule shell, and at least one optically variable and magnetically alignable pigment that is substantially freely rotatable in the microcapsule and reversibly alignable by an external magnetic field, and that is developed to be multilayer having at least one magnetic layer and having at least one non-magnetic layer. or having a security arrangement with a verification element having a magnetic region, the security element and the verification element of the security arrangement being geometrically arranged on the data carrier in such a way that the security element is bringable over the verification element by bending or folding the data carrier.
